(19) United States
(12) Patent Application Publication
(10) Pub. No.: US 2017/0211740 A1
(43) Pub. Date: Jul. 27, 2017

(54) Heatable Tube

(71) Applicant: ContiTech Techno-Chemie GmbH, Karben (DE)

(72) Inventors: Gunther Daniel, Friedberg (DE); Joachim Stein, Friedberg (DE)

(73) Assignee: ContiTech Techno-Chemie GmbH, Karben (DE)

(21) Appl. No.: 15/321,202

(22) PCT Filed: May 26, 2015
(86) PCT No.: PCT/EP2015/061499

§ 371 Date: Dec. 22, 2016

(30) Foreign Application Priority Data
Jul. 25, 2014 (DE) 10 2014 214 687.9

(51) Int. Cl. F16L 53/00; F01N 3/20; F16L 11/127

(52) U.S. Cl. CPC F16L 53/008; F16L 11/127; F01N 3/2066; F01N 2610/10

(57) ABSTRACT

The invention relates to a heatable tube (1) for conducting fluid, gaseous and/or pasty media, comprising an outer wall (10) that encloses an inner volume (11), and a heating element (2) which is arranged inside the inner volume (11) and which includes at least one first heating conductor (20a) that is surrounded by a first heating conductor insulation (21) insulating the heating conductor from the inner volume (11). The invention is characterized in that the first heating conductor insulation (21) insulating the heating conductor from the inner volume (11) is surrounded by a second heating conductor insulation (22).

The invention relates to a heatable hose for conducting fluid, gaseous and/or pasty media, as per the preamble of claim 1, and to a motor vehicle having a heatable hose of said type, as per claim 12.

Heatable hoses are known in a wide variety of embodiments, in particular as electrical heatable hoses, for example for use in motor vehicles. Alternatively, heatable hoses are known in the case of which a heated medium, for example in the form of a liquid, is used. Depending on the temperature of said medium in relation to the medium conducted in the hose, the latter medium can be heated or even cooled. The medium flowing in said hoses between two connector points is heated or cooled by said hoses.

One application for this is for example the heating of urea-based liquids such as are used for the exhaust-gas aftertreatment of automobile diesel engines for the reduction of the nitrogen oxides, known as SCR technology (selective catalytic reduction). Such an additive is known under the trade name AdBlue®. The heating may be necessary because the additive freezes at temperatures below approximately minus 10° C.

An electrically heatable hose having at least one electrical heating conductor which serves for heating a medium flowing in the hose is known for example from DE 102 01 920 A1, wherein the heating conductor extends over at least a partial region of the length of the hose and is composed of a metallic core and of a casing. The heating conductor is normally embedded in a layer of the hose. In the case of a multi-layer hose, the heating conductor may also be arranged between two layers. In the case of this type of heating of the fluid, the electrical heating conductor heats all of the hose material surrounding it.

A disadvantage here is that only a part of the heating power is transmitted into the interior of the hose and thus to the fluid. A part of the heating power is however transmitted outward and is released, unutilized, to the surroundings, that is to say said fraction of the heating power constitutes a loss. This can rather give rise to undesired heating of other vehicle components which come into contact with or absorb heat from the heatable hose.

The use of heatable hoses is also known for windshield washing installations for the purposes of preventing the freezing of the washing water or thawing out the frozen washing water water more quickly or in the first place. In the case of such relatively thin hoses, the heating conductor is led within the hose line with a casing which electrically insulates it with respect to the washing water. The encased heating conductor is in this case arranged loosely within the internal volume of the hose, in effect floating freely in the washing water. At the ends of the hose line, the encased heating conductor is led out of the washing water for example at the connectors. These passages of the encased heating conductor through the connectors are normally sealed off by way of O-rings composed of elastomer material or by way of an elastomer body.

EP 2 706 208 A1 relates to a plug connector having a housing which has a receiving space, a connector piece and a duct which connects the receiving space and the connector piece, wherein a heating zone is provided in the interior of the duct. For the fast heating of a liquid line having a plug connector of said type, it is provided that a heat-conducting element is arranged between the heating zone and the receiving space. The heat element extends into the receiving space. A seal arrangement in the form of two O-rings is arranged in the receiving space, and the heat element extends through the seal arrangement.

EP 2 527 704 A1 relates to a connector for a fluid line having a housing which has a connector piece, which is connectable to a pipe, and a connection geometry, which is connectable to a counterpart element. To be able to lead an auxiliary element out of a fluid line and keep the risk of leakage low, it is provided that the housing has an outlet opening through which at least one auxiliary element is led out of the housing to the outside, wherein the auxiliary element is led through an elastomer body which, under the action of pressure parallel to the passing-through direction of the auxiliary element through the elastomer body, expands perpendicularly to the passing-through direction and is possibly held in the outlet opening by way of a holder device. The holding device may have a cap which at least partially covers the outlet opening and which may be screwed, snapped, pressed, adhesively bonded or welded onto the housing.

An advantage of said encased heating conductor arranged in the fluid in relation to the arrangement within the outer wall of the hose is that the electrically generated heat is released entirely to the washing water surrounding the heating conductor.

However, the arrangement of the heating conductor arranged in the fluid cannot be transferred to the use of urea-based liquids in the SCR field, because said liquids would chemically and/or physically attack both the casing of the heating conductor and also the seal composed of elastomer material. The former situation would lead to a degradation, to the point of destruction, of the heating conductor, and the latter situation would lead to leaks.

It is an object of the present invention to provide a heatable hose of the type described in the introduction, the heating conductor of which is arranged in the internal volume of the hose and is encased in a fluid-resistant manner.

The object is achieved according to the invention by way of a heatable hose for conducting fluid, gaseous and/or pasty media, having the features of claim 1, and by way of a motor vehicle having the features of claim 12. Advantageous developments are described in the dependent claims.

Thus, the present invention relates to a heatable hose for conducting fluid, gaseous and/or pasty media, having an outer wall, which encloses an internal volume, and a heating element, which is arranged within the internal volume. This is advantageous because, in this way, the heating element is in direct contact with the medium and can release its heating power over its full extent, directly and in the best possible manner to said medium.

This reduces the heat losses to the surroundings and increases the efficiency of the heatable hose. In the case of a cylindrical hose, the heating element is of correspondingly cylindrical form and floats, as it were, freely in the medium, for example a fluid urea solution of an SCR system.

The heating element has at least one first heating conductor which is surrounded with respect to the internal volume by a first heating conductor insulator. The heating conductor may be a medium-guiding conductor, for example in the form of a hose, in which a heated medium, such as for example liquid, is conducted. As an electrical heating conductor, said heating conductor is firstly electrically conductive in order to be able to conduct electrical current, but secondly exhibits such a high electrical resistance that sufficient electrical current heat losses are generated in order to sufficiently heat the surrounding medium for the respective usage situation.

The electrical heating conductor may be a metallic or textile conductor. For example, the electrical heating conductor may comprise an alloy composed of chromium-nickel or copper, or may be composed of said alloy alone or may be composed of said unalloyed material. It is advantageous here that said metals exhibit a similarly high electrical resistance and, in this way, it is possible for higher electrical current heat losses to be generated than with metals with low electrical resistance. As textile conductors, use may be made of materials which exhibit electrical conductivity but which at the same time have the flexibility of a textile material. The textile conductors may have fibers which may be monofilaments or multifilaments, which may be in the form of a yarn or thread. These may form a linear textile conductor or may be in the form of a textile sheetlike structure. As material, use may be made of carbons such as carbon fibers or carbon nanotubes.

The heatable hose is characterized in that the first heating conductor insulator is surrounded with respect to the internal volume by a second heating conductor insulator. Here, the second heating conductor insulator surrounds the first heating conductor insulator, that is to say is arranged between the first heating conductor insulator and the internal volume.

The second heating conductor insulator makes it possible for the latter to be designed with regard to its insulating effect with respect to the medium that is conducted in the internal volume, without modification of the existing construction of the heating conductor and of its first heating conductor insulator. This simplifies the usage, and reduces the costs.

The design of the second heating conductor insulator may be performed for example with regard to the chemical resistance for example with respect to a fluid urea solution of an SCR system. Alternatively or in addition, the design may be performed with regard to the greatest possible thermal conductivity in order that the heat from the electrical heating conductor can be transmitted with the least possible losses, and as quickly as possible, to the medium. Alternatively or in addition, the design may be performed with regard to high pressure resistance, if the medium is conducted at high pressure.

Here, the invention is based on the realization that, by way of the second heating conductor insulator, a conventional arrangement, known for example for windshield wiper installations, for heating the washing water can be refined easily and inexpensively for use for example with SCR technology, and in this way, the advantages of the as far as possible direct and complete release of heat to the urea liquid can be utilized in that field also.

According to one aspect of the present invention, the heating element has at least one second (heating) conductor which is surrounded with respect to the internal volume by a first heating conductor insulator. Said conductor may likewise be in the form of a heating conductor. In this way, the heating power can be increased, approximately doubled. Also, more possibilities for the generation of the electrical heating are realized, because it is also possible for two different heating conductors to be used in combination with one another. Alternatively, said second conductor may however also have some other function, such as for example signal transmission. In this way, it is possible to dispense with separate lines outside the hose, which simplifies the construction thereof. Furthermore, lines guided within the hose are protected against external influences.

According to a further aspect of the present invention, the first heating conductor and the second heating conductor are jointly surrounded with respect to the internal volume by the second heating conductor insulator. This simplifies the construction and holds the two heating conductors together.

According to a further aspect of the present invention, the first heating conductor is a first electrical heating conductor, and/or the second heating conductor is a second electrical heating conductor, in the form of an electrically conductive cable, an electrically conductive thread or an electrically conductive element. A cable is to be understood to mean a metallic conductor, composed preferably of copper, which may be composed of one or more preferably twisted-together strands. An electrically conductive thread is a textile electrically conductive element composed for example of an electrically conductive plastics material. An electrically conductive element may for example be a substantially punctiform heating element to which a feed is provided by way of electrical supply lines and which releases its heating power locally, whereas a cable or a thread has a uniform cross section and releases its heating power substantially uniformly over its length.

According to a further aspect of the present invention, the first electrical heating conductor and/or the second electrical heating conductor are/is a PTC resistor. A PTC (Positive Temperature Coefficient) resistor has a current-conducting material which can conduct the current more effectively at relatively low temperatures than at high temperatures. The electrical resistance thereof increases with rising temperature. This type of resistor thus has a positive temperature coefficient. This is advantageous for this application because the one or more electrical heating conductors are intended to be operated in a heated environment, that is to say they are, during their use, permanently exposed to, and operated in, their own heat.

According to a further aspect of the present invention, the outer wall has an elastomer, a plastic, in particular a polyamide (PA), in particular PA 12, or polypthalamide (PPA) or polyphenylene sulfide (PPS), or a polyurethane. The use of elastomers is advantageous owing to their elasticity. The use of plastics and in particular polyamides is advantageous owing to their excellent strength and ductility. Furthermore, they exhibit good chemical and physical resistance with respect to organic solvents, and can be easily processed. In particular, owing to its chemical and physical resistance, polyamide 12 is suitable, and has been tried and tested, for use with the medium urea solution. For example, PA 12 exhibits good hydrolysis resistance, such that, even with permanent use over for example 3000 h to 5000 h, the physical characteristic values of the material deteriorate to a relatively lesser extent than in the case of other polyamides. The plastics PPA and PPS are suitable for usage situations at relatively high temperatures, and can furthermore be very easily (laser-) welded.

According to a further aspect of the present invention, the first heating conductor insulator has a fluorocarbon, a perfluoro (ethylene propylene) plastic (FEP), a modified fluoroalkoxy (MFA) or a perfluoroalkoxy alkane (PFA). Fluorocarbons are distinguished by their water-repellent nature. The use of FEP (also referred to as fluorinated ethylene propylene), which is used as a water-repellent coating for flexible substrates, is particularly advantageous.

According to a further aspect of the present invention, the second heating conductor insulator has an elastomer, a plastic, in particular a polyamide (PA), in particular PA 12, or polypthalamide (PPA) or polyphenylene sulfide (PPS), or a polyurethane. The same characteristics and advantages as already described above with respect to the outer wall apply to the heating conductor insulator.

According to a further aspect of the present invention, the outer wall and at least the second heating conductor insulator are connected by way of an adapter element. By way of said adapter element, the electrically heatable hose can be connected to other elements such as further hoses or assemblies. Here, the adapter element also has a passage in order to make it possible for the fluid to be conducted into the internal volume and out of the internal volume and exchanged with the other hoses or assemblies. The adapter element is preferably a quick-action connecting element (quick connector) which simplifies and thereby expedites the mounting of the electrically heatable hose.

According to a further aspect of the present invention, the adapter element has an adapter body which is connected to the second heating conductor insulator by way of a cohesive connection. The cohesive connection intensifies the sealing action of said connection, such that the sealing action is maintained in particular in the presence of relatively high pressures of the medium. Furthermore, it is possible to dispense with separate seal elements such as for example an O-ring, which simplifies the construction.

According to a further aspect of the present invention, the cohesive connection is a laser-welded connection, a rotary-welded connection or an adhesive connection. All of these connection types lead to a pressure-resistant connection. Laser welding and rotary welding are used preferably in the case of a second heating conductor insulator composed of polyamide, and an adhesive connection is used in particular in the case of a second heating conductor insulator composed of elastomer material.

The present invention also relates to a motor vehicle having a heatable hose as described above. In this way, the advantages described above can be utilized in a motor vehicle, in particular in an SCR system of a motor vehicle.

Two exemplary embodiments and further advantages of the invention will be discussed below in conjunction with the following figures. In the figures:

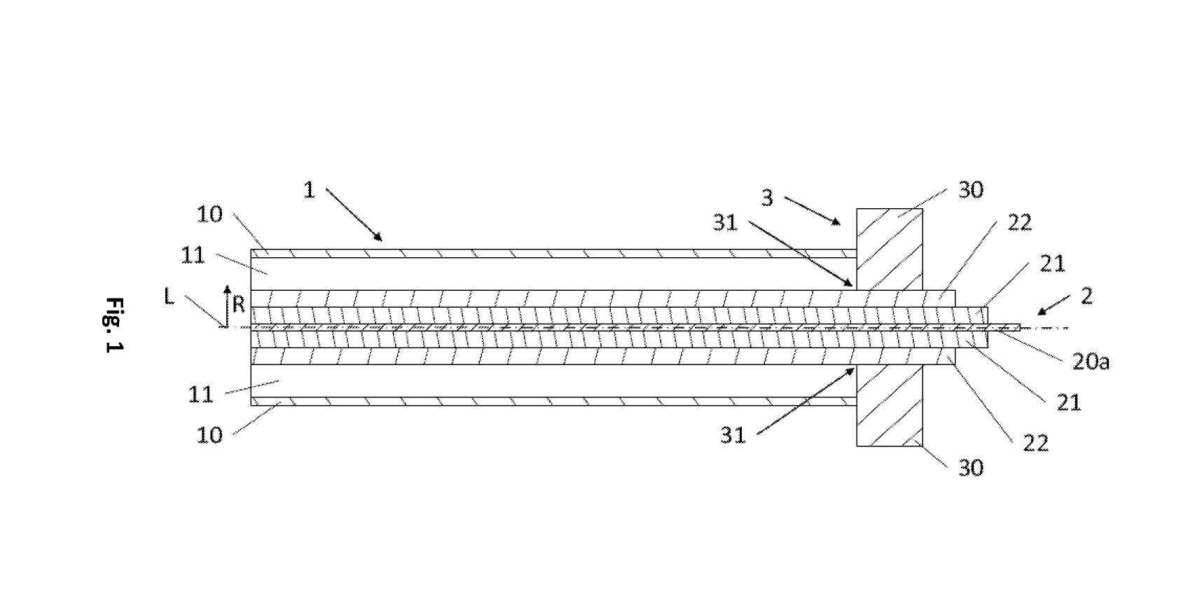

FIG. 1 is a schematic sectional illustration of a heatable hose according to the invention as per a first embodiment; and

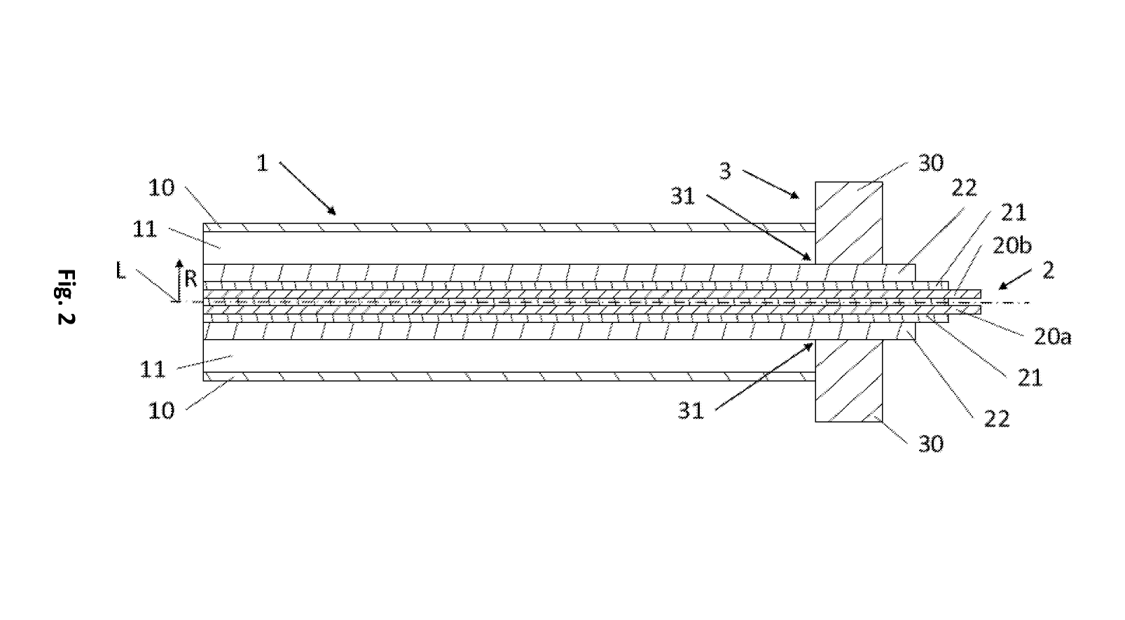

FIG. 2 is a schematic sectional illustration of a heatable hose according to the invention as per a second embodiment.

FIG. 1 is a schematic sectional illustration of a heatable hose 1 according to the invention as per a first embodiment. The heatable hose 1 is of cylindrical form along a longitudinal axis L and is illustrated with an open end on the left and with an end equipped with an adapter element 3 on the right.

The heatable hose 1 has an elastic outer wall 10 composed of an elastomer material, which outer wall encloses an internal volume 11 which, in this illustration, is furthermore delimited on the right-hand side by the adapter element 3 and is illustrated as being open toward the left. A medium such as for example a fluid can be conducted within said internal volume 11. In the case of an SCR system, the SCR hose 1 conducts an aqueous urea solution as fluid.

A heating element 2 in the form of an electrical heating element 2 is arranged, on the longitudinal axis L, in as far as possibly freely floating fashion in the internal volume 11 or fluid, which heating element is arranged so as to be uniformly spaced apart in a radial direction R from the inner side of the outer wall 10. This arrangement is however illustrated schematically for better comprehension, because the freely floating electrical heating element 2 adapts to the profile of the hose 1, which may also be curved depending on the application.

In this first exemplary embodiment, the electrical heating element 2 has a first electrical heating conductor 20a in the form of a thin copper cable or a thin copper-containing cable through which electrical current can flow in order to generate electrical heat losses and, by means thereof, heat the fluid in the internal volume 11. The first electrical heating conductor 20a is encased by a first heating conductor insulator 21 which chemically insulates said first electrical heating conductor with respect to liquids and at the same time permits a good transfer of heat to the internal volume 11. According to the invention, the first heating conductor insulator 21 is lined with a second heating conductor insulator 22 which additionally in particular chemically insulates the first heating conductor insulator 21 with respect to the internal volume 11 or the fluid such as for example the aqueous urea solution. In this way, the advantage of the direct transfer of heat of the freely floating electrical heating element 2 can also be utilized in usage situations with chemically aggressive fluids such as the aqueous urea solution of an SCR system.

The adapter element 3 has an adapter body 30 which is connected to the second heating conductor insulator 22 in pressure-tight fashion by way of a cohesive connection 31, such as for example a laser-welded or rotary-welded connection 31 or an adhesive connection 31.

FIG. 2 is a schematic sectional illustration of a heatable hose 1 according to the invention as per a second embodiment. Here, a second electrical heating conductor 20b is additionally arranged within the second heating conductor insulator 22 in order to increase the electrical heat losses and thus the heating power. The second electrical heating conductor 20b is likewise encased by the first heating conductor insulator 21. Here, the two heating conductors 20a, 20b in this exemplary embodiment are jointly encased by the first heating conductor insulator 21 and then by the second heating conductor insulator 22. Alternatively, the two heating conductors 20a, 20b may also be in each case spatially separately encased by the same first heating conductor insulator 21 or else by different first heating conductor insulators 21 and then by the common second heating conductor insulator 22 which, in this case, separates the two first heating conductor insulators 21 from one another, that is to say is also arranged between the two, 20a and 20b. This can simplify the production because the two heating conductors 20a, 20b with their respective first heating conductor insulator 21 can be produced separately and are thereafter brought together for the first time within the second heating conductor insulator 22.

Alternatively, the second electrical heating conductor 20b may also be used as an electrical conductor 20b for other purposes, such as for example for signal transmission or for an electrical feed to an electrical heating element (not illustrated). Then, the electrical resistance of the second electrical conductor 20b is correspondingly set such that the focus is on the as far as possible loss-free transmission of electrical energy rather than the generation of electrical current heat losses.

### LIST OF REFERENCE SIGNS

### Part of the Description

L Longitudinal axis
R Radial direction, perpendicular to longitudinal axis L
1 (Electrically) heatable hose, SCR hose
10 Outer wall
11 Internal volume
2 (Electrical) heating element
20a First (electrical) heating conductor
20b Second (electrical) (heating) conductor
21 First heating conductor insulator
22 Second heating conductor insulator
3 Adapter element, connector element, quick connector
30 Adapter body, connector body
31 Cohesive connection between second heating conductor insulator 22 and adapter body 30, laser-welded connection, rotary-welded connection, adhesive connection

1.-12. (canceled)

13. A heatable hose comprising:
an outer wall enclosing an internal volume; and
a heating element which is arranged within the internal volume;
wherein the heating element has at least one first heating conductor which is surrounded with respect to the internal volume by a first heating conductor insulator and a second heating conductor insulator; and,
wherein the outer wall comprises polyamide, polypthalamide, polyphenylene sulfide, or polyurethane.

14. The heatable hose as claimed in claim 13, wherein the heating element further comprises a second conductor which is surrounded with respect to the internal volume by the first heating conductor insulator.

15. The heatable hose as claimed in claim 14, wherein the first heating conductor and the second conductor are jointly surrounded with respect to the internal volume by the second heating conductor insulator.

16. The heatable hose as claimed in claim 13, wherein the first heating conductor is a first electrical heating conductor, and the second conductor is a second electrical heating conductor in the form of one of an electrically conductive cable, an electrically conductive thread or an electrically conductive element.

17. The heatable hose as claimed in claim 16, wherein the first electrical heating conductor and the second electrical heating conductor are PTC resistors.

18. The heatable hose as claimed in claim 13, wherein the first heating conductor insulator comprises a perfluoro (ethylene propylene) plastic, modified fluoroalkoxy, or perfluoroalkoxy alkane.

19. The heatable hose as claimed in claim 13, wherein the second heating conductor insulator comprises polyamide, polypthalamide, polyphenylene sulfide, or polyurethane.

20. The heatable hose as claimed in claim 13, wherein the outer wall and at least the second heating conductor insulator are connected by way of an adapter element.

21. The heatable hose as claimed in claim 20, wherein the adapter element comprises an adapter body which is connected to the second heating conductor insulator by way of a cohesive connection.

22. The heatable hose as claimed in claim 21, wherein the cohesive connection is one of a laser-welded connection, a rotary-welded connection, or an adhesive connection.

23. A heatable hose comprising:
an outer wall enclosing an internal volume; and
a heating element which is arranged within the internal volume;
wherein the heating element has at least one first heating conductor which is surrounded with respect to the internal volume by a first heating conductor insulator and a second heating conductor insulator; and,
wherein the first heating conductor insulator comprises a perfluoro (ethylene propylene) plastic, modified fluoroalkoxy, or perfluoroalkoxy alkane.

24. The heatable hose as claimed in claim 23, wherein the heating element further comprises a second conductor which is surrounded with respect to the internal volume by the first heating conductor insulator.

25. The heatable hose as claimed in claim 24, wherein the first heating conductor and the second conductor are jointly surrounded with respect to the internal volume by the second heating conductor insulator.

26. The heatable hose as claimed in claim 23, wherein the first heating conductor is a first electrical heating conductor, and the second conductor is a second electrical heating conductor in the form of one of an electrically conductive cable, an electrically conductive thread or an electrically conductive element.

27. The heatable hose as claimed in claim 26, wherein the first electrical heating conductor and the second electrical heating conductor are PTC resistors.

28. The heatable hose as claimed in claim 23, wherein the outer wall comprises polyamide, polypthalamide, polyphenylene sulfide, or polyurethane.

29. The heatable hose as claimed in claim 23, wherein the second heating conductor insulator comprises polyamide, polypthalamide, polyphenylene sulfide, or polyurethane.

30. The heatable hose as claimed in claim 23, wherein the outer wall and at least the second heating conductor insulator are connected by way of an adapter element.

31. The heatable hose as claimed in claim 30, wherein the adapter element comprises an adapter body which is connected to the second heating conductor insulator by way of a cohesive connection.

32. A heatable hose comprising:
an outer wall enclosing an internal volume; and
a heating element which is arranged within the internal volume;
wherein the heating element has at least one first heating conductor which is surrounded with respect to the internal volume by a first heating conductor insulator and a second heating conductor insulator; and,
wherein the outer wall and at least the second heating conductor insulator are connected by way of an adapter element comprising an adapter body which is connected to the second heating conductor insulator by way of a cohesive connection.

33. The heatable hose as claimed in claim 32, wherein the cohesive connection is one of a laser-welded connection, a rotary-welded connection, or an adhesive connection.
